(19) United States
(12) Patent Application Publication
(10) Pub. No.: US 2002/0096943 A1
(43) Pub. Date: Jul. 25, 2002

(54) Brush powered linear motor

(75) Inventor: Yihshay Netzer, Yuvalim (IL)

Correspondence Address: DR. MARK FRIEDMAN LTD., c/o Bill Polkinghorn, Discovery Dispatch, 9003 Florin Way, Upper Marlboro, MD, 20772, US

(73) Assignee: NETZER PRECISION MOTION SENSORS LTD.

(21) Appl. No.: 10/025,799

(22) Filed: Dec. 26, 2001

Related U.S. Application Data
(60) Provisional application No. 60/257,942, filed on Dec. 26, 2000.

(51) Int. Cl. H02K 41/00

(52) U.S. Cl. 310/12

(57) ABSTRACT

A linear motor of the moving coil type, without a flexible power cable attached to the moving coils assembly. Current is supplied to the moving coils assembly by means of continuous sliding contacts and its position is measured by a contact less position sensor.

### FIELD OF THE INVENTION

The invention relates to the field of linear motors and more generally to linear motion closed loop control systems.

### BACKGROUND OF THE INVENTION

Generally linear motors comprise an electromagnetic actuator and a linear position and motion sensor, together with a servo motion controller and its software and a power amplifier, they constitute a motion control servo loop that responds to an input command. The electromagnetic actuator can be of either the moving coil type or of the moving magnet type. The moving coil actuator basically comprises a stationary linear array of permanent magnets and a moving coils assembly, which needs an electrical connection to the stationary controller and power amplifier. The actuator of a moving magnet motor comprises a stationary array of coils wherein only the coils) adjacent to the magnet are energized at any time. This may be done by means of electronic power switches that switch on and off in accordance with the instantaneous position of the magnet assembly relative to the stationary coils. The switching (referred to as commutation) commands are generated based on the measured position of the magnet assembly as obtained by a position and motion sensor. Alternatively the commutation can be implemented by sliding contacts attached to the moving magnet array, such motor is described for example in U.S. Pat. No. 459.5870. A moving magnet is not the subject of this invention and does not need a cable for powering of the moving magnet; the use of sliding contacts is mentioned only as a reference to the present invention.

Conventional moving coil linear motors employ a flexible-cable, or harness to supply the actuating currents to the moving coils assembly. These currents are supplied by a stationary power amplifier, which is commanded by the motion controller, in accordance with the position of the moving coils assembly relative to the stationary magnets array which is supplied by a linear position sensor. In general, the use of a flexible power cable (- harness) has several disadvantages: it is cumbersome, it is expensive and its reliability is limited.

Prior attempts have been made to power the coils assembly without a cable connection, for example, in U.S. Pat. 473.3143 the coils assembly is powered via brushes which are mounted on the coils assembly and are sliding on segmented rails that switch on and off the currents of the coils In the moving assembly, depending on its position This method not only obviates the power cable but also the need to switch the currents electronically. However, since the sliding contacts open and close periodically as the coil assembly moves. they deteriorate over time and additionally generate interfering noise due to arcing. In any case, such commutating brushes do not obviate the need for a harness that serves the position sensor, which is still needed for close loop operation.

### DESCRIPTION OF THE FIGURES

FIG. 1 illustrates a block diagram of the linear motor of the present invention.

### BRIEF DESCRIPTION OF THE INVENTION

The object of the present invention is to provide a moving coil type linear motor, which does not need a flexible cable to power the moving coils assembly. The moving coils assembly is energized by means of brush contacts sliding along continuous rails to provide continuous electrical contacts with no arcing. In the preferred embodiment of the invention the position sensor is also of a cable less type therefore no cable is needed.

### DETAILED DESCRIPTION OF THE INVENTION

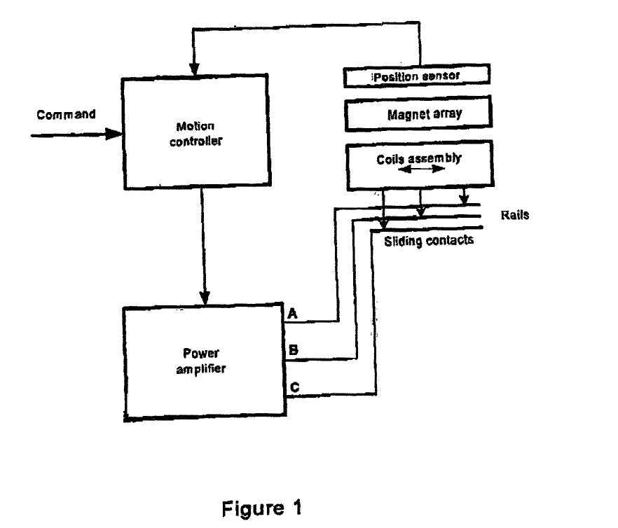

It was found by the inventor that transferring power to a moving coil assembly in a moving coil type motor via continuous sliding contacts, rather than through segmented contacts as in prior art provides reliable electrical contacts without the danger of arcing. The commutation is performed by electronic switches in a stationary amplifier, in conjunction with a controller which receives information on the position of the coils assembly from a sensor—see FIG. 1. In a preferred embodiment of the invention the position sensor is of a cable less type, i.e., it does not need its own flexible cable. The result is a moving coil assembly with no need for any flexible cable. Such cable less position and motion sensor is described in U.S. patent applications 09/294749 and 138983.

FIG. 1 illustrates a typical implementation of the invention in which the coils assembly includes three separate coils (—not shown) fed by three phases A, B, and C. Accordingly there are three bushes fixed relative to the moving coils assembly, which are sliding on three stationary rails along the travel axis. In the preferred embodiment of the invention the power rails are made of printed circuit substrate with silver plated copper traces. The brushes are preferably made of carbon loaded with silver particles. In contrast with prior art the rails are not segmented and the sliding contacts are not interrupted as the coils assembly moves. Accordingly the sliding contacts do not arc do not generate noise that could interfere with the operation of the position and motion sensor, and are durable. The contacts thus establish continuous connection between the moving coils assembly and a stationary controller and amplifier and from the standpoint of the controller and amplifier the coils are indistinguishable from conventional coils in a linear motor with flexible power cable. The invention thus does not need special control hardware.

1. A linear motor of the moving coil type including;
a stationary magnets array;
a coils assembly movable along a mechanical guide and facing said magnet array;
a sensor for sensing the position of said coils assembly relative to said magnets;
a motion controller with power amplifier that accepts position signals from said sensor and generates currents for the energizing the coils assembly;
at least three stationary conductive rails parallel said guide and connected to said power amplifier;
at least three brush contacts that are mechanically attached and electrically connected to said coils assembly and which are sliding along said rails as the coils assembly moves;
Said coil assembly is powered by said motion controller and amplifier via said brush contacts to generate motion that is sensed by said sensor.

2. A linear motor as in claim 1 wherein said position and motion sensor is of the cable less type.
